(19) United States
(12) Patent Application Publication
(10) Pub. No.: US 2025/0033938 A1
(43) Pub. Date: Jan. 30, 2025

(54) ACCESSORY DEVICE MOUNTABLE TO AN EXCAVATOR BASE

(71) Applicants: Wilhelm DEGEN, Bangkok (TH); Alexander DEGEN, Schwindegg (DE)

(72) Inventors: Wilhelm Degen, Bangkok (TH); Alexander Degen, Schwindegg (DE); Manuel Stapel, Wuelfershausen (DE)

(73) Assignees: Wilhelm DEGEN, Bangkok (TH); Alexander DEGEN, Schwindegg (DE)

(21) Appl. No.: 18/710,655

(22) PCT Filed: Nov. 18, 2022
(86) PCT No.: PCT/EP2022/082507

§ 371 Date: May 16, 2024

(30) Foreign Application Priority Data
Nov. 18, 2021 (DE) 102021130141.6

(51) Int. Cl. B66C 23/74; B66C 23/80; E02F 3/627

(52) U.S. Cl. CPC B66C 23/74; B66C 23/80; E02F 3/627

(57) ABSTRACT

An accessory device is mountable to an excavator frame of an excavator base. The excavator base, which includes an undercarriage, the excavator frame and a ring gear arranged between the undercarriage and the excavator frame, is configured to allow for rotation of the excavator frame relative to the undercarriage. The accessory device includes a mounting frame, a mount for holding a mast, and at least two outriggers. The mounting frame includes connection elements configured to connect the accessory device to mating connection elements of the excavator frame. The at least two outriggers are directly connected to the carrier frame and configured to support the carrier frame on the ground.

### TECHNICAL FIELD

This application relates to an accessory device mountable to an excavator base, a construction machine system, a construction machine and a method for mounting an accessory device to an excavator base.

### BACKGROUND

Construction equipment, e.g. used to drill holes in soil or rock, operates typically using a carrier rig and a mast. Examples of such a construction equipment are illustrated in FIGS. 1A-1C. The construction equipment includes a carrier rig 1 and a mast 2 in front of the carrier rig 1. On such a mast 2 a drill string with drill motor or alternatively a so-called sheet pile vibrator holding a metal or other material piece that is driven into the soil is manipulated up and down using a sled that runs guided by the mast. In a particular application there can also be a top fed or bottom fed depth vibrator rig mounted to the sled. The sled is moved up and down the mast using wire ropes, chains or any other similar propulsion. However, such sled and drill or vibrator attachments are omitted in some the drawings for the sake of clarity.

According to one conventional construction machine illustrated in FIG. 1A, the mast 2 can be suspended such that it hinges around a lower suspension point 30 and is on the top held by typically a pair of so-called backstop cylinders 31.

According to another conventional construction machine illustrated in FIGS. 1B and 1C, a so-called pantograph (parallelogram) mast 2 can be used in order to move quicker and with more precision from drill point to drill point than with the setup of FIG. 1A. FIGS. 1B and 1C illustrate the pantograph mast 2 in a contracted state (i.e. with the mast 2 closest to the excavator base) and in an expanded state (i.e. with the mast 2 furthest away from the rig 1), respectively.

### SUMMARY OF THE INVENTION

While having the advantage over the setup according to FIG. 1A of increasing speed and precision of moving from drill point to drill point, the pantograph (parallelogram) setup according to FIGS. 1B and 1C has various disadvantages over the setup of FIG. 1A, e.g.:
A) Substantially higher overall weight of the rig 1.
B) Compared to the expanded state, the bottom of the mast 2 is much higher above ground in the contracted state, thus not allowing to use the drill string (here not shown) on the mast 2 to its full extent downward.
C) Additional costs due to an expensive arm 20 and additional cylinders 21, 22.
D) Attachment of the parallelogram mast to an existing excavator by removing a digging arm of the excavator and installing in its position a parallelogram setup according to FIGS. 1B and 1C is not possible within the space constraints of a typical excavator arm suspension.

A first aspect relates to an accessory device mountable to an excavator frame of an excavator base. The excavator base, which includes an undercarriage, the excavator frame and a ring gear arranged between the undercarriage, and the excavator frame, is configured to allow for rotation of the excavator frame relative to the undercarriage. The accessory device includes a mounting frame, a mount for holding a mast and at least two outriggers. The mounting frame includes connection elements configured to connect the accessory device to mating connection elements of the excavator frame. The at least two outriggers are directly connected to the carrier frame and configured to support the carrier frame on the ground.

A second aspect relates to a construction machine system which includes an excavator base and an accessory device according to the first aspect. The excavator base includes an undercarriage, an excavator frame and a ring gear arranged between the undercarriage and the excavator frame and configured to allow for rotation of the excavator frame relative to the undercarriage.

A third aspect relates to a construction machine which includes a construction machine system according to the second aspect. The accessory device is mounted to the excavator frame in that the connection elements of the mounting frame are connected to mating connection elements of the excavator frame.

A fourth aspect relates to a method for mounting an accessory device to an excavator base. The method includes the steps of providing an accessory device according to the first aspect; providing an excavator base which includes an excavator frame. The excavator frame includes mating connection elements that match the connection elements of the accessory device; and mounting the accessory device to the excavator base by connecting the connection elements of the mounting frame to the mating connection elements of the excavator frame.

A fifth aspect relates to a construction machine which includes a construction machine base configured to hold a construction tool at a front side of the construction machine base and a rear side frame connected to the construction machine base. The rear side frame carries a second function counterweight on a rear side of the construction machine base, wherein the rear side is opposite to the front side. In addition to its function as a counterweight, the second function counterweight takes over a second technical function. Further, the construction machine is configured to lower the second function counterweight towards the ground (200).

### BRIEF DESCRIPTION OF THE DRAWINGS

The embodiments described below can be better understood with reference to the following drawings and descriptions. The components in the figures are not necessarily to scale; instead, emphasis is placed upon illustrating the principles of the system described herein. Moreover, in the figures, like reference numerals designate corresponding parts. In the drawings:

FIG. 1A schematically illustrates a conventional construction machine that includes a mast which hinges around a lower suspension point and is held by a pair of backstop cylinders.

FIGS. 1B and 1C schematically illustrate a conventional construction machine that includes a pantograph mast.

FIG. 2A is a perspective view of a construction machine that includes an accessory device mounted to an excavator base of an excavator.

FIG. 2B schematically illustrates a cross-sectional view of a screwed connection between an excavator base and a mounting frame of an accessory device.

FIG. 3A schematically illustrates a side view of the construction machine of FIG. 2 with an expander stem in a contracted state.

FIG. 3B schematically illustrates a side view of the construction machine of FIG. 2 with the expander stem in a fully expanded state.

FIG. 4A is a perspective view of a part of the construction machine of FIG. 2 with the expander stem in the contracted state.

FIG. 4B is a perspective view of a part of the construction machine of FIG. 2 with the expander stem in the fully expanded state.

FIG. 5 is a perspective view of an accessory device for a construction machine.

FIGS. 6A and 6B are different perspective views of a construction machine working sideways over the front of tracks of an excavator base.

FIG. 7 is a side view showing an electric generator or hydraulic power pack mounted to a rear side of an excavator base of a construction machine.

FIGS. 8A and 8B are perspective views of the lifting device illustrated in FIG. 7.

FIG. 9 is rear view of the lifting device illustrated in FIG. 7.

FIGS. 10A and 10B are cross-sectional side views of the lifting device illustrated in FIG. 7.

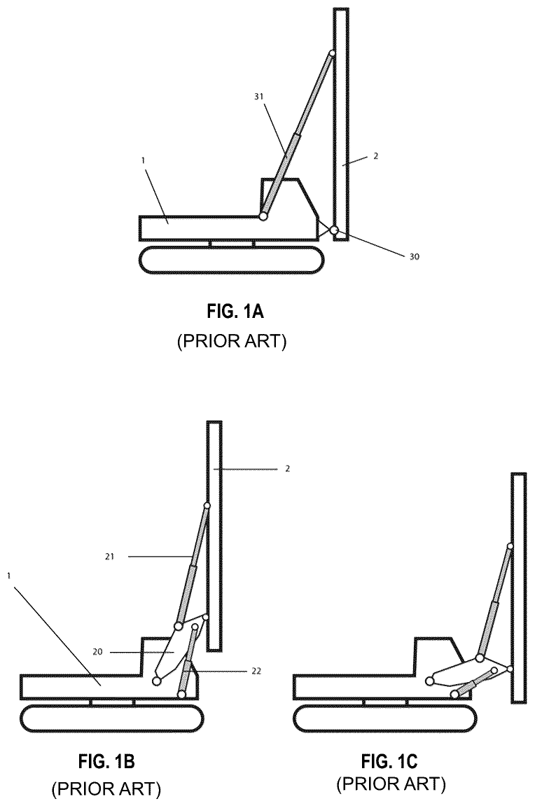

### DETAILED DESCRIPTION

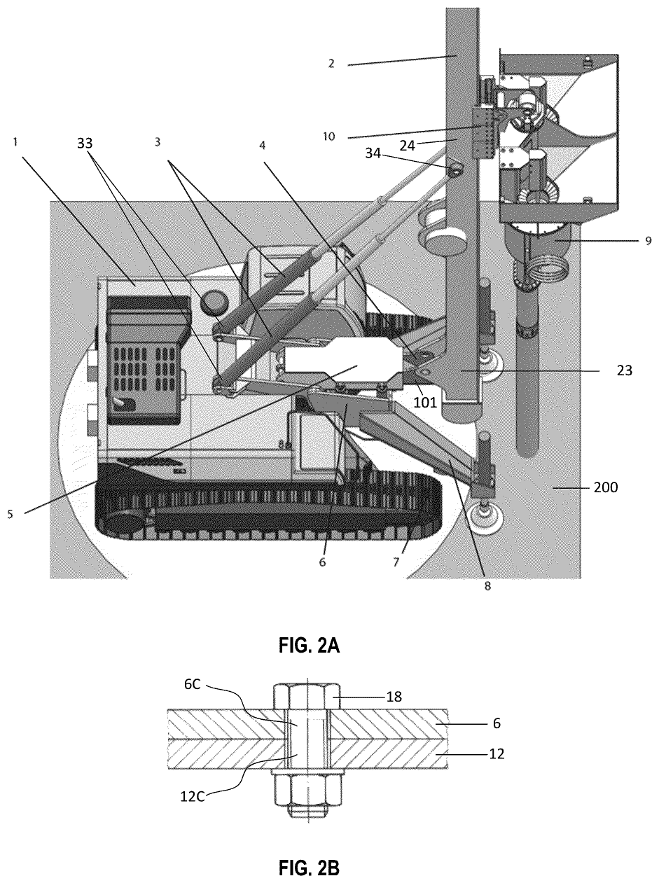

FIG. 2A is a perspective view of a construction machine that includes an accessory device mounted to an excavator base 1 of an excavator. Prior to mounting the accessory device to the excavator base 1, a digging arm of the excavator has been removed from the excavator base 1 and replaced by the accessory device. Using an excavator base of an already existing excavator allows to compose a specialty construction machine without having to manufacture the whole construction machine.

An accessory device as illustrated by way of example in FIG. 2A may include an arbitrary combination of a mounting frame 6, two or more outriggers 8 connected to the mounting frame 6, a swivel frame 5 connected to the mounting frame 6, and an expander stem 4 mounted to the mounting frame 6. As shown in FIG. 2, the optional expander stem 4 may be integrated into the swivel frame 5.

The accessory device 100 is mountable to the excavator base 1 by connecting connection elements of the mounting frame 6 to mating connection elements of an excavator frame 12 (c.f. FIGS. 4A and 4B) of the excavator base 1. For example, suitable connection elements of the mounting frame 6 may be pins or bolts or bolt eyes or hinges (eyes for bolts or shafts) that are customarily present at the excavator frame 12 of the upper carriage 1t in order to hold the excavator arm (that has been removed prior to mounting the accessory device 100 to the excavator frame 12), and suitable mating connection elements of the excavator frame 12 may also be pins or bolts or bolt eyes or hinges. In other words, the mounting frame 6 will be held by the excavator frame 12 via the same or some of the same connection elements as the previously the (removed) excavator arm. In order to mount the accessory device 100 to the excavator frame 12, each of one or more mating connection elements 12C of the excavator frame 12 (e.g. a bolt eye) may be connected with a corresponding one of one or more connection elements 6C of the mounting frame 6 (e.g. a bolt eye), e.g. using a screw bolt so that pairs of mounting elements (e.g. bolt eyes), one of the excavator frame 12 and (a mating) one of the mounting frame 6, are screwed together as schematically illustrated in FIG. 2B using a bolted connection 18. However, instead of connection elements 6C and mating connection elements 12C formed as bolt eyes, any other suitable connection elements that allow for releasable connections, e.g. clamp connections, may be used.

In order to be able to connect the accessory device 100 to different excavator bases 1, the mounting frame 6 of the accessory device 100 may be equipped with different sets of connection elements 6C so that a first set of connection elements 6C can be used to connect the mounting frame 6 to the mating connection elements 12E of the excavator frame 12 of a first type of excavator base 1, a second set of connection elements 6C can be used to connect the mounting frame 6 to the mating connection elements 12C of the excavator frame 12 of a second type of excavator base 1, and so on.

That is, the connection elements 6C of the mounting frame 6 may be arranged at different locations in space depending on the make of the excavator frame 12 of the excavator base 1 that is used.

The accessory device 100 may include a mount 101 that is used to hold a bottom section 23 of a mast 2. For instance, the connection between the mount 101 and the bottom section 23 of the mast 2 may be a hinge point connection allowing to tilt the mast 2 around a horizontal axis defined by the hinge point connection. As illustrated in FIG. 2A, the mount 101 may be formed by an end of an expander stem 4 connected to the mounting frame 6. However, in some embodiments the expander stem 4 may be omitted and the mount 101 may be part of the mounting frame 6.

In order to hold the mast 2 in an upright (vertical or slightly inclined with respect to the vertical) orientation, the accessory device 100 may include a holding arrangement 3 connected to both the mounting frame 6 and a top section 24 of the mast 2. Without being restricted to, the holding arrangement 3 may include one or more backstop cylinders 31 each of which including a first end 33 connected to the mounting frame 6 and a second end 34 connected to the top section 24 of the mast 2. In the embodiment of FIG. 2A, the holding arrangement 3 includes two backstop cylinders 31. However, only one or more than two backstop cylinders 31 would also be possible. In order to connect the holding arrangement 3 to the mounting frame 6 and to the top section 24 of the mast 2, bolt-eye-connections or any other suitable connections may be used.

According to the embodiment illustrated in FIG. 2A, a sled 10 carrying a top or bottom fed depth vibrator rig 9 may be attached to and guided by the mast 2 so that the sled 10, together with the top or bottom fed depth vibrator rig 9, may move along the mast 2 up and down. It is to be noted that, instead of a sled-guided bottom feed depth vibrator rig 9, any other construction tool may be attached to the mast 2 as well. The same applies for embodiments other than that explained with reference to FIG. 2A.

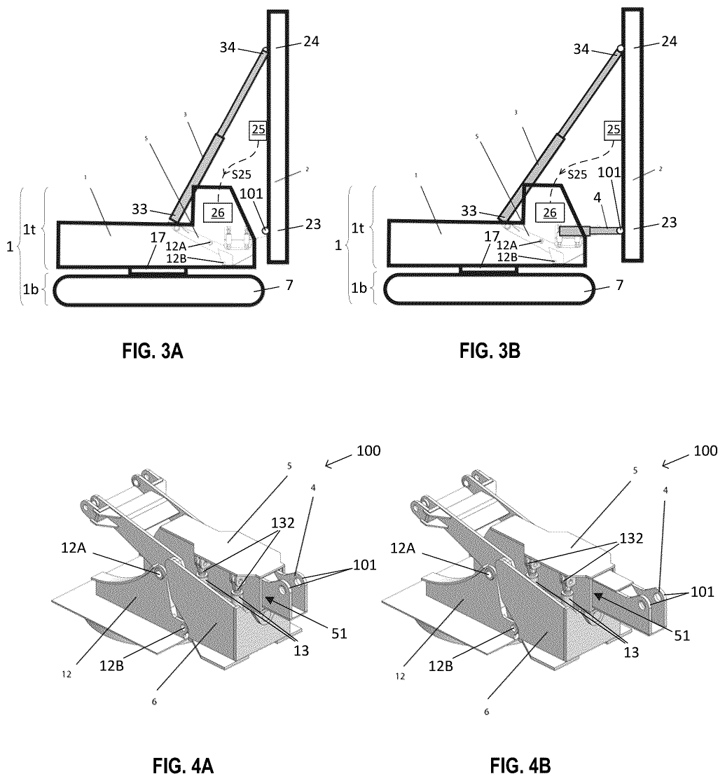

As can be seen from the side views of FIGS. 3A and 3B, which show the construction machine of FIG. 2A, the excavator base 1 includes an undercarriage 1b and an upper carriage 1t which are connected via a ring gear 17 which allows the upper carriage 1t to rotate relative to the undercarriage 1b. In order to move on the ground 200 (FIG. 2A), the undercarriage 1b may include tracks 7 or, alternatively, wheels. FIG. 3A shows the construction machine with the expander stem 4 in a contracted position, in which the bottom section 23 of the mast 2 is closest to the excavator base 1 and the mounting frame 6 (and the tracks 7 or wheels of an undercarriage 1B of the excavator base 1) and in which the expander stem 4 is almost not visible, and FIG. 3B shows the construction machine of FIG. 2A in a fully expanded position, in which the bottom section 23 of the mast 2 is furthest from the excavator base 1 and the mounting frame 6 (and the tracks 7 or wheels of the undercarriage 1B). For the sake of clearness, the outriggers 8 are omitted in FIGS. 3A and 3B.

FIGS. 4A and 4B illustrate one possible embodiment of the accessory device 100 connected at its mounting frame 6 to an excavator frame 12 of the excavator base 1 via mounting points (i.e. connection elements; c.f. 12C in FIG. 2B) that are normally provided for mounting the digging arm of the excavator to the excavator frame 12. The swivel frame 5 is connected to the mounting frame 6 and can be tilt relative to the mounting frame 6 via at set of at least two, at least three or at least four individually controllable adjustment cylinders 13 in order to adjust the inclination of the mast 2, which is not shown in FIGS. 4A and 4B but may be attached to the mount 101 of the expander stem 4 as shown in FIGS. 2A, 3A and 3B, by tilting the swivel frame 5 relative to the mounting frame 6.

Each of the adjustment cylinders 13 may include a first end (not visible in FIGS. 4A and 4B) connected to the mounting frame 6, and a second end 132 connected to the swivel frame 5. As also illustrated in FIGS. 4A and 4B, the swivel frame 5 may have a longitudinal opening 51 that serves as a guide for the expander stem 4.

Depending on the particular construction measure, it may be necessary to adjust the mast 2 in a vertical orientation or in a predetermined orientation that is inclined with respect to the vertical. For this purpose, as schematically shown in FIGS. 3A and 3B, an inclination sensor 25, which is connected to the mast 2 and which outputs a signal S25 indicating the inclination of the mast 2 (e.g. with respect to the vertical), may be used. This signal S25 may be supplied to a control unit 26 as a feedback signal via a wired or a wireless connection as schematically illustrated in FIGS. 3A and 3B by dashed lines. Based on the signal S25, the control unit 26 may control the holding arrangement 3, the expander stem 4 and adjustment cylinders 13 or any selection thereof in such a way that the predetermined inclination of the mast 2 is achieved.

For instance, the mast 2 may first be brought in a substantially orientation using the holding arrangement 3 (course adjustment). Subsequently, the predetermined inclination (e.g. a vertical orientation) of the mast 2 may be adjusted based on the inclination signal S25 using at least one of the expander stem 4 and the set of adjustment cylinders 13. According to one embodiment, the construction machine system may be configured to move the mast 2 such that an inclination of the mast 2 remains unchanged during an expansion or contraction of the expander stem 4.

FIGS. 4A and 4B also show connection points 12A and 12B at which the mounting frame 6 is connected to the excavator carrier 12. These connection points 12A and 12B are also illustrated in FIGS. 3A and 3B.

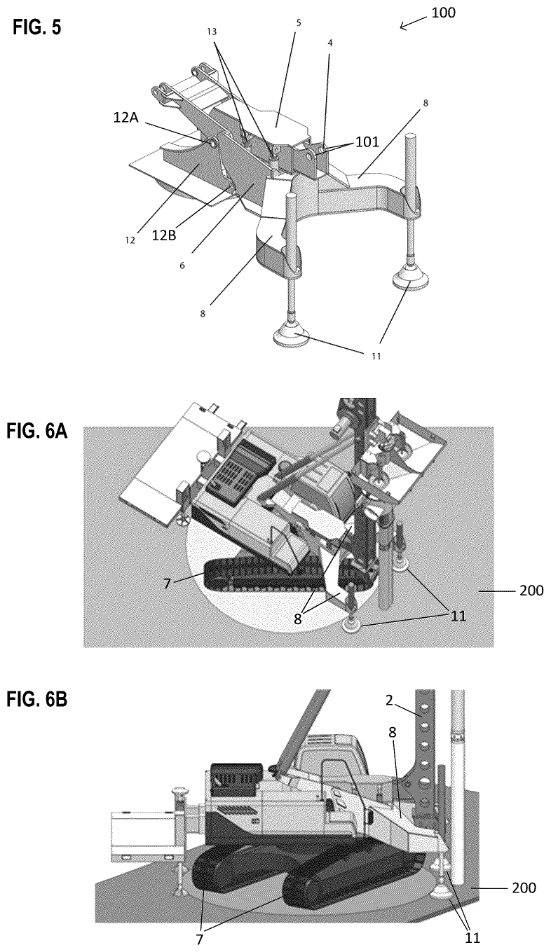

FIG. 5 shows the same parts as FIGS. 4A and 4B but now with the optional addition of outriggers 8 to each of which a front side end foot 11 is attached. In the sense of the present description, the “front side” is the side of the excavator base 1 (or excavator frame 12) on which the mast 2 is located, and the “rear side” is the side opposite to the front side (or excavator frame 12). In order to save space during transportation, the outriggers 8 may be at least one of detachable from the mounting frame 6, retractable, foldable and telescopic. Detachable connections between the outriggers 8 and the mounting frame 6 may be screw connections, bolt-eye-connections, or the like. Alternatively, the connections between the outriggers 8 and the mounting frame 6 may be inseparable connections like welded connections.

In principle, the outriggers 8 could be omitted. In practice, however, the outriggers 8 have a high practical value of reducing the load on a ring gear which is arranged between the excavator frame 12 and the undercarriage 1b (which includes the tracks 7 or wheels) and which allows a rotation of the excavator frame 12 relative to the undercarriage 1b (e.g. a rotation of) 360°, when the tools mounted to the mast 2 that are entering the soil are pushed or pulled with large vertical forces by the sled 10.

Connecting the outriggers 8 directly to the mounting frame 6 means the forces from the front side end feet 11 are favorably entering the excavator frame 12 of the upper carriage 1t of the excavator base 1 and hence not burden the ring gear arranged between the undercarriage 1b and the excavator frame 12 with large moment loads, which would be the case if such outriggers 8 were connected to the undercarriage as can be seen in some conventional equipment. The connection of such outriggers 8 to the mounting frame 6 has the benefit that the upper carriage 1t of the excavator base 1 does not need to be modified and could with limited effort later be back converted to a standard excavator with a digging arm and without the outriggers 8.

The combination of parts as described with reference to FIG. 5 allows to keep the mast 2 very close to the center of gravity of the excavator base 1 which is beneficial for stability, while the expander stem 4 allows for a quick reaching of next work points without excessive traveling on the tracks 7 (or wheels) of the undercarriage 1b. The bottom section 23 of the mast 2 stays just above the tracks 7 (or wheels) but not much higher so that the bottom section 23 can swing over the tracks 7 (or wheels), e.g. about 360°, without collision.

FIGS. 6A and 6B illustrate one of the achievements of the system described herein: The outriggers 8 and the mast 2 do not collide with the tracks 7 (or wheels) of the excavator base 1 if the upper carriage 1t is rotated relative to the undercarriage 1b (e.g. by) 360° using the ring gear 17. This allows the construction machine to work more points from the same track (or wheel) position and do this in the most stable way, with the mast 2 as close to the center of gravity of the excavator base 1 as possible without sacrificing the ability to rotate the upper carriage 1t fully on the ring gear 17. A single support foot under the mast would not have allowed for such optimizations as it would have interfered with the tracks 7 (or wheels) or make it necessary to have the mast 2 further away from the center of rotation of the ring gear 17. Therefore, a support foot arranged between the bottom of the mast 2 and the ground 200 may be omitted.

According to the above description, an accessory device 100 for a construction machine may include a mounting frame 6 with connection elements 6C, a mount 101 for holding a mast 2, and two or more outriggers 8. In addition and without being restricted to, the accessory device 100 may include one or more of the following optional components: a swivel frame 5 tiltable relative to the mounting frame 6, a mast 2, a holding arrangement 3 (e.g. one or more backstop cylinders 31), and an expander stem 4. Each of the optional components may (directly or indirectly) be mounted to the mounting frame 6 prior to or after mounting the mounting frame 6 of the accessory device 100 with its connection elements 6C to the mating connection elements 12C of the excavator frame 12. It is to be noted that the outriggers 8 are mounted to the mounting frame 6 in such a manner that, during a rotation of the mounting frame 6 relative to the undercarriage 1b using the ring gear 17 with the front side end feet 11 lifted away from the ground 200, the outriggers 8 rotate together with the mounting frame 6.

The possibility to mount an accessory device 100 to an excavator base 1 allows to use an existing excavator already present at the location of a remote construction site, while the accessory device 100 can be transported to this site in a standard 40 ft shipping container. That is, the accessory device 100 including the mounting frame 6, the mast 2, the holding arrangement 3, the swivel plate 7 (if provided), the adjustment cylinders 13 (if provided) and the expander stem 4 (if provided), at least in a folded or dismantled configuration, can be accommodated in a 40 ft shipping container having the inside dimensions 12032 mm×2350 mm×2393 mm (length×width×height). In contrast, conventional excavators or drill rigs due to their geometric dimensions normally can only be shipped with much more expensive and less seldom travelling roll-on roll-off ships and not container ships.

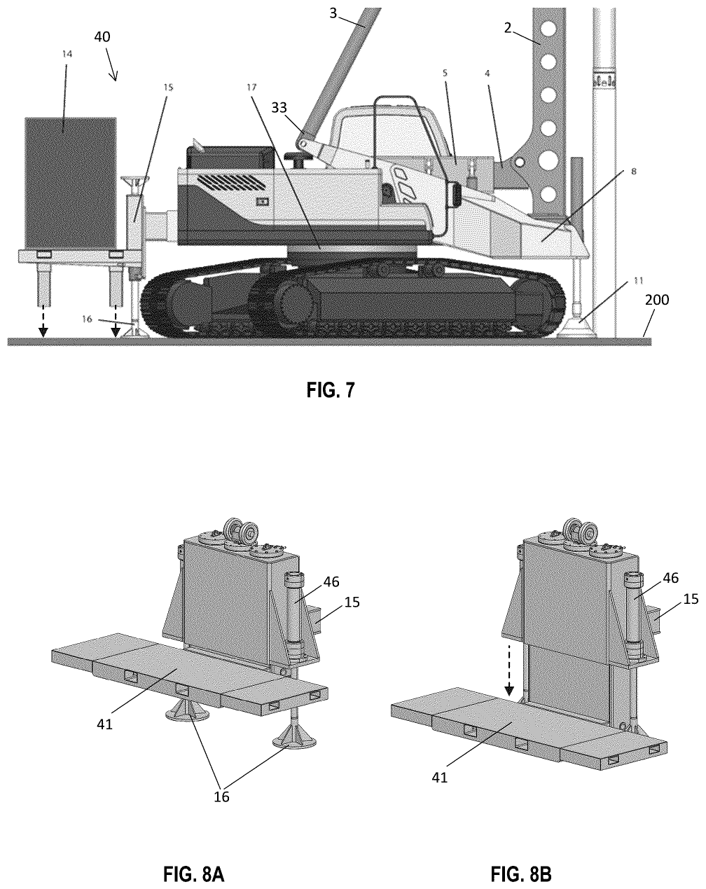

FIG. 7 shows a further aspect of the system described herein according to which to a rear side frame 15 that is connected to the excavator base 1 includes a lifting device 40 that carries a second function counterweight 14 on the rear side of the excavator base 1 in lieu of or in addition to the standard counterweight often used with conventional excavators. In addition to its function as a counterweight, the second function counterweight 14 takes over a second technical function, in particular at least one of an electrical, electromechanical, hydraulic or pneumatic function required for the operation of the construction machine. Without being restricted to, examples for such a second function counterweight 14 include a motor (e.g. combustion or electric or hydraulic or pneumatic), an electric generator, a battery pack, a power conversion unit, a compressor, a pump (electric or hydraulic or pneumatic) or a hydraulic power pack or any combination thereof. One, two or more than two retractable rear side feet 16 may be attached to the rear side frame 15. In combination with the front side feet 11, the retractable rear side feet 16 greatly reduce the stress on the ring gear 17 when vertical forces act onto the mast 2. The at least one retractable rear side foot 16 may be configured to assume a first configuration in which the second function counterweight 14 is arranged on or close to the ground 200, and a second configuration in which, as compared to the first configuration, the second function counterweight 14 is arranged spaced more distant from the ground 200.

According to a further option schematically illustrated by dashed arrows, the construction machine may be configured to lower the counterweight 14 towards and/or to the ground 200 for easier access to the counterweight 14, e.g. for service and for removal of the counterweight 14 at the end of a project. For example, the lowering may be accomplished by using the retractable rear side foot/feet 16 as jack(s) to lower the counterweight 14 relative to the rear side frame 15. Conversely, the construction machine may be configured to lift the counterweight 14 away from the ground 200 in order to place the counterweight 14 in its working position. For example, the lifting may be accomplished by using the retractable rear side foot/feet 16 as jack(s) to lift the second function counterweight 14 away from the ground 200.

FIGS. 8A and 8B show perspective views of the lifting device 40 illustrated in FIG. 7. As compared to FIG. 7, the second function counterweight 14 is omitted for the sake of clearness. The lifting device 40 includes a mount 41, e.g. a platform or the like, to which the second function counterweight 14 may be attached. The mount 41, together with the second function counterweight 14 attached to the mount 41, may be moved to a lifted position (FIG. 8A) and moved to a lowered position (FIG. 8B) in which the mount 41 and the counterweight 14 is closer to the ground 200 (FIG. 7) than in the lifted position. In both the lifted position and the lowered position, the at least one rear side foot 16 rests on the ground 200.

The lifting and lowering of the mount 41 and the counterweight 14 attached to the mount 41 may take place using two adjustment mechanisms: A first adjustment mechanism which is part of the at least one retractable rear side foot 16 with which the distance between the rear side carrier 15 and the ground 200 can be adjusted. Changing the distance between the rear side carrier 15 and the ground 200 also changes the distance between the mount 41 (and the second function counterweight 14 attached to it) and the ground; and a second adjustment mechanism that can be used in order to adjust a relative position between the mount 41 and the rear side carrier 15. As illustrated in FIGS. 8A and 8B, the first adjustment mechanism may be realized by at least one rear side foot cylinders 46 (e.g. one rear side foot cylinder 16 for each rear side foot 16).

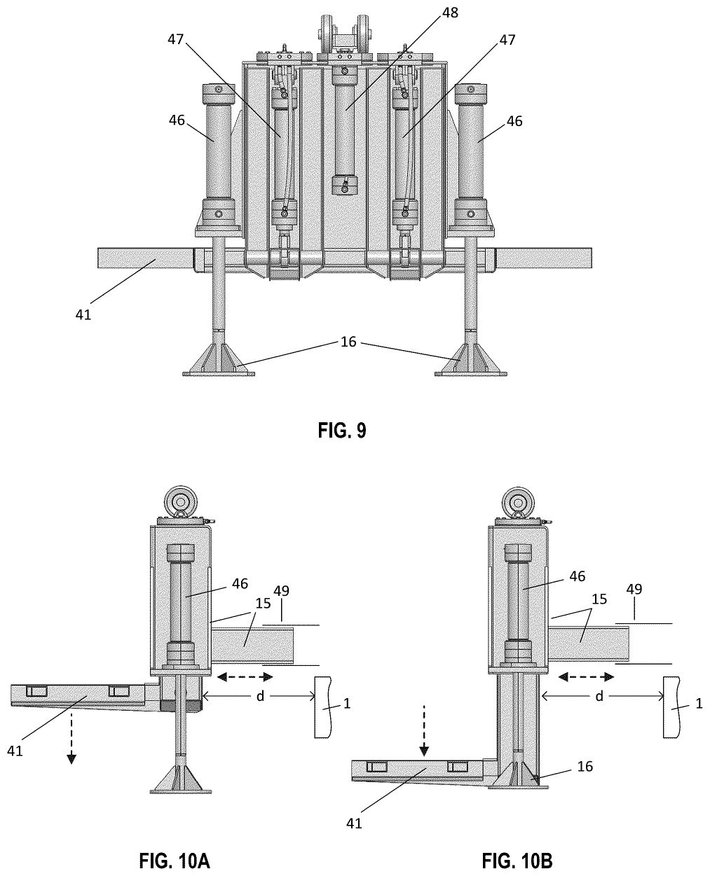

In order to illustrate the second adjustment mechanism, reference is made to FIG. 9 which is rear view of the lifting device 40. The second adjustment mechanism may include at least one (two in the present embodiment) further cylinders 47 which can be used in order to adjust the relative position between the mount 41 and the rear side carrier 15. FIGS. 10A and 10B are cross-sectional side views illustrating the lowered position of the mount 41 (FIG. 10A) and the lifted position of the mount 41 (FIG. 10B), respectively.

According to a further embodiment also illustrated in FIGS. 10A and 10B, the rear side frame 15 may include at least one load arm cylinder 49 through which a horizontal distance d between the machine base 1 and the second function counterweight 14 is adjustable (telescopic function) in order to allow for adjusting the momentum caused by the second function counterweight 14.

A still further optional cylinder 48 illustrated in FIG. 9 allows for adjusting the mast 2 and is not required for the function of the lifting device 40.

It is to be noted that the features described in connection with FIGS. 7, 8A, 8B, 9, 10A and 10B can be used not only on an excavator but on any construction machine. It is further to be noted that the features described in connection with these figures can be used with a base of any construction machine (e.g. a base like the described excavator base 1) which, at a front side (i.e. the side opposite the rear side), carries any construction tool like a mast, a digging arm, or the like and which requires a counterweight on the rear side. In other words, the liftable and lowerable counterweight 14 can be attached to the rear side of all kinds of construction machines that carry any construction tool on the front side.

In the following, some example embodiments of the present system described herein are summarized here. Other embodiments can also be understood from the entirety of the specification and the claims filed herein.

Example 1: A device consisting of a mounting frame (6) that connects to the connection points on the rig chassis typically reserved for an excavator arm or a crane mast. Such mounting frame having on the back the backstop cylinders (31) or similar supports connected and on the front the mast (2).

Example 2: Device under example 1 connected with a swivel frame (5) that allows via cylinders (13) or other adjustment means that the mast (2) can be adjusted in its inclination perpendicular to the driving direction of the excavator.

Example 3: Device under example 1 or 2, with an expander stem (4) such that forward or backward movement of such expander stem (4) allows lateral movement of the mast (2) thereby enabling the rig to quicker and with more precision reach positions in space.

Example 4: Device as per example 3, where the expander stem (4) is moved inside the swivel frame (5) having a longitudinal opening that serves as a guide for the expander stem (4) thereby saving overall weight and space.

Example 5: Device as per all previous examples, where outriggers (8) are connected to the mounting frame (6) to increase the overall stability of the carrier rig (1) during work, bringing the outrigger forces via the mounting frame (6) into the upper part of the carrier rig (1).

Example 6: Mast (2) and outriggers (8) designed in a way that they do not conflict with the position of the tracks or wheels of the carrier rig (1) when rotating on the ring gear while the position of the mast is as close to the center of gravity of the carrier rig (1) as possible.

Example 7: Lateral movement of the expander stem (4) coordinated with the movement of the backstop cylinders (31) in a way that the mast (2) stays in the same preferably vertical incline during the lateral expansion or contraction of the expander stem (4). In one variant this is accomplished by electronically automated hydraulic controls that use mast inclination angle as feedback for maintaining mast angle during the lateral movement.

Example 8: Additional to a device according to examples 1 to 5, a frame (15) with integrated retractable feet (16) is attached to the back of the rig so both upward and downward forces from the sled (FIG. 2, item 10) are taken up by feet (11) and feet (16) instead of the ring gear (FIG. 7, item 17).

Example 9: The part of the frame (15) according to example 8 that carries the generator (14) can be lowered to the ground for easier access to such generator (14) for service and for its removal at the end of a project. The lowering can be for example accomplished by using the retractable feet (16) as jacks to lower that part of the frame (15).

1. An accessory device mountable to an excavator frame of an excavator base, the excavator base including an undercarriage, the excavator frame and a ring gear arranged between the undercarriage and the excavator frame and configured to allow for rotation of the excavator frame relative to the undercarriage, the accessory device comprising:
a mounting frame that includes connection elements that connect the accessory device to mating connection elements of the excavator frame;
a mount that holds a mast; and
at least two outriggers directly connected to a carrier frame that support the carrier frame on the ground.

2. The accessory device of claim 1 further comprising:
a swivel frame tiltable relative to the mounting frame.

3. The accessory device of claim 2 further comprising:
a plurality of adjustment cylinders that tilt the swivel frame relative to the mounting frame.

4. The accessory device of claim 3, wherein each of the adjustment cylinders includes a first end connected to the mounting frame and a second end connected to the swivel frame.

5. The accessory device of claim 1 further comprising:
an expander stem that allows for a lateral movement of the mount.

6. The accessory device of claim 1 further comprising:
a mast connected to the mount; and
a holding arrangement connected to both the mounting frame and the mast that holds the mast in an upright orientation.

7. The accessory device of claim 6, wherein the holding arrangement includes at least two backstop cylinders.

8. A construction machine system comprising:
an excavator base that includes an undercarriage, an excavator frame and a ring gear arranged between the undercarriage and the excavator frame to allow for rotation of the excavator frame relative to the undercarriage; and
an accessory device having a mounting frame that includes connection elements that connect the accessory device to mating connection elements of the excavator frame, a mount that holds a mast, and at least two outriggers directly connected to a carrier frame that support the carrier frame on the ground, wherein the accessory device is mountable to the excavator frame by connecting the connection elements of the mounting frame to the mating connection elements of the excavator frame.

9. The construction machine system of claim 8 further comprising:
an inclination sensor that provides an inclination signal representing an inclination of the mast.

10. The construction machine system of claim 9 further comprising:
an inclination control that receives the inclination signal as a feedback signal and moves the mast to adjust a predetermined inclination of the mast based on the inclination signal.

11. The construction machine system of claim 10, wherein the inclination control moves the mast such that an inclination of the mast remains unchanged during an expansion or contraction of an expander stem that allows for a lateral movement of the mount.

12. The construction machine system of claim 8 further comprising:
a rear side frame connected to the excavator frame, the rear side frame carrying a second function counterweight at a rear side of the excavator base, the rear side being opposite to a front side, the second function counterweight, in addition to functioning as a counterweight, taking over a second technical function.

13. The construction machine system of claim 12 further comprising:
at least one retractable rear side foot attached to the rear side frame and assuming a first configuration in which the second function counterweight is arranged on or close to the ground, and the at least one retractable rear side foot assuming a second configuration in which, as compared to the first configuration, the second function counterweight is arranged spaced more distant from the ground.

14. The construction machine system of claim 12, wherein the second function counterweight is lowered towards the ground.

15. The construction machine system of claim 14, wherein the second function counterweight is lowered towards the ground using the at least one retractable rear side foot one or more jacks.

16. The construction machine system of claim 8, wherein the undercarriage includes at least one of: wheels or tracks and wherein in a state, in which the accessory device is mounted to a carrier rig, the mounting frame is rotatable relative to the wheels or tracks such that the mast and the at least two outriggers do not conflict with the wheels or tracks.

17. The construction machine of claim 8, wherein the accessory device is mounted to the excavator frame by connecting the connection elements of the mounting frame to the mating connection elements of the excavator frame.

18. A method for mounting an accessory device to an excavator base, comprising:
providing an accessory device having a mounting frame that is part of the excavator base and that includes connection elements that connect the accessory device to mating connection elements of an excavator frame, a mount that holds a mast, and at least two outriggers directly connected to a carrier frame that support the carrier frame on the ground; and
mounting the accessory device to the excavator base by connecting the connection elements of the mounting frame to the mating connection elements of the excavator frame.

19. The method of claim 18, further comprising:
disconnecting a previously connected accessory device from the excavator base by disconnecting the connection elements of the mounting frame from the mating connection elements of the excavator frame prior to mounting the accessory device to the excavator base.

20. A construction machine comprising:
a construction machine base that holds a construction tool at a front side of the construction machine base; and
a rear side frame connected to the construction machine base, the rear side frame carrying a second function counterweight on a rear side of the construction machine base, the rear side being opposite to the front side, and the second function counterweight, in addition to functioning as a counterweight, taking over a second technical function, wherein the construction machine is configured to lower the second function counterweight towards the ground.

21. The construction machine of claim 20 further comprising:
at least one retractable rear side foot attached to the rear side frame and configured to assume a first configuration in which the second function counterweight is arranged on or close to the ground, and a second configuration in which, as compared to the first configuration, the second function counterweight is arranged spaced more distant from the ground.

22. The construction machine of claim 20 further comprising:
at least one mount that holds the second function counterweight, wherein a distance between the mount and the ground is adjustable by adjusting a relative position between the mount and the rear side frame.

23. The construction machine of claim 20, wherein the rear side frame includes at least one load arm cylinder through which a horizontal distance between the machine base and the second function counterweight is adjustable.
